(19) United States
(12) Patent Application Publication
(10) Pub. No.: US 2011/0054105 A1
(43) Pub. Date: Mar. 3, 2011

(54) BARRIER COATING COMPOSITES WITH HYPERPLATY CLAY AND POLYESTER MATRIX RESIN

(76) Inventors: Carrie A. Feeney, Bridgewater, NJ (US); Michele Farrell, Bethlehem, PA (US); Harris A. Goldberg, Edison, NJ (US)

(21) Appl. No.: 12/736,136

(22) PCT Filed: Feb. 27, 2009
(86) PCT No.: PCT/US09/01244

§ 371 Date: Oct. 19, 2010

Related U.S. Application Data
(60) Provisional application No. 61/069,460, filed on Mar. 14, 2008.

(51) Int. Cl. C08K 3/34

(52) U.S. Cl. 524/446

(57) ABSTRACT

An aqueous barrier coating composition in the form of a dispersion includes: (a) water; (b) a polyester matrix polymer; (c) a platy to hyperplaty kaolin filler having an average shape factor of at least about 40:1, the composition being further characterized in that: (i) the composition has a solids content of from more than 20 weight percent up to 70 percent by weight; (ii) the composition has a weight ratio of polyester matrix polymer:kaolin filler of from 4:1 to 0.75:1; and (iii) a film formed from the composition exhibits at least 5-fold reduction in oxygen permeability as compared with a like film formed of said polyester matrix polymer. Also disclosed are barrier coatings derived from the compositions as well as packaging composites incorporating a barrier film formed from the compositions.

### CLAIM FOR PRIORITY

This non-provisional application claims the benefit of the filing date of U.S. Provisional Patent Application Ser. No. 61/069,460, of the same title, filed Mar. 14, 2008. The priority of U.S. Provisional Patent Application Ser. No. 61/069,460 is hereby claimed and the disclosure thereof is incorporated into this application by reference.

### JOINT RESEARCH AGREEMENTS

The claimed inventions were made by, on behalf of, and/or in connection with one or more of the following parties to joint research agreements: MeadWestvaco Corporation, Imerys Clays Inc., and InMat Inc. The applicable agreements are: (1) A three party JDA effectively dated Feb. 28, 2008 among MeadWestvaco Corporation, Imerys Clays Inc., and InMat Inc.; (2) a JDA effectively dated Jun. 1, 2006 between MeadWestvaco Specialty Chemicals, LLC and Imerys Clays Inc.; and (3) a JDA effectively dated May 3, 2006 between MeadWestvaco Corporation and InMat Inc. One or more of these agreements were in effect on and before the date the claimed inventions were made, and the claimed inventions were made as a result of activities undertaken within the scope of one or more of the aforesaid agreements.

### FIELD OF INVENTION

The present invention relates generally to polymer/clay dispersions which are used to provide coatings having enhanced barrier properties. The coating compositions have a high barrier to gas permeation and are thus suitable for packaging perishables such as milk, foodstuffs and the like as well as oxygen sensitive inks, electronic components and so forth. The invention also relates to a method of making aqueous concentrated barrier coating compositions by selectively removing a portion of the aqueous medium.

### BACKGROUND OF THE INVENTION

Barrier coatings which prevent, reduce, or inhibit the permeation of a selected substrate with a gas, vapor, chemical and/or aroma have been widely described, and such coatings are used in a variety of industries, e.g., the packaging industry, automobile industry, paint industry, and tire industry. For example, butyl rubber in automobile tires has been coated with formulations which include a polymer and a platelet filler, in order to reduce the air permeability of the tire. See, e.g., U.S. Pat. Nos. 4,911,218 and 5,049,609. Tires with integral innerliners are disclosed in U.S. Pat. No. 5,178,702. Similarly, it has been well described in the literature that barrier properties are of great importance for packaging food, beverage, or other products that are sensitive to environmental influences.

United States Patent Application Publication No. US2004/0121079 of Urscheler et al., which is incorporated herein by reference in its entirety, discloses a method of producing a multi-layer coated substrate having improved barrier properties. The method described therein allows one to produce a coated substrate having at least two layers of coating which imparts different barrier functionalities including oil and/or grease barrier functionality, water vapor barrier functionality, water resistance functionality, solvent barrier functionality, aroma barrier functionality, and oxygen barrier functionality.

It has also been reported that certain hydrous mineral materials, such as for example, kaolin, imparts certain advantageous properties in a variety of coating compositions. For example, U.S. Pat. No. 6,758,895 to Wesley, which is incorporated herein by reference in its entirety, discloses a hyperplaty particulate mineral material suitable for use as an opacifying pigment or filler. U.S. Pat. Nos. 7,208,039; 7,214,264 and 7,226,005 to Jones et al., all of which are incorporated herein by reference in their entirety, disclose hyperplaty clays and their use in coating and filling. U.S. Pat. Nos. 6,616,749 and 6,814,796 to Husband et al., which are incorporated herein by reference in their entirety, disclose a platy kaolin useful for coating. U.S. Pat. Nos. 6,537,363 and 6,610,137 to Golley et al., which are incorporated herein by reference in their entirety, also disclose a platy kaolin useful for coating. U.S. Pat. No. 6,564,199 to Pruett et al., which is incorporated herein by reference in its entirety, likewise discloses a platy kaolin for coating. U.S. Pat. No. 6,808,559 to Golley et al., which is incorporated herein by reference in its entirety, discloses a platy kaolin useful in coating and filling compositions.

Despite the advances in the art, there exists a need for an aqueous coating composition that exhibits enhanced gas barrier properties, which may be applied to various substrates using existing technology without the need for highly specialized equipment that requires large capital investment to convert existing production lines or install new production lines.

### SUMMARY OF THE INVENTION

There is provided an aqueous barrier coating composition in the form of a dispersion which includes: (a) water; (b) a polyester matrix polymer; (c) a platy kaolin functional additive having an average shape factor of at least about 40:1, the composition being further characterized in that: (i) the composition has a solids content of from more than 20, up to 70 percent by weight; (ii) the composition has a weight ratio of polyester matrix polymer:kaolin additive of from 4:1 to 0.75:1; and (iii) a film formed from the composition exhibits at least 5-fold reduction in oxygen permeability as compared with a like film formed of said polyester matrix polymer. Also disclosed are barrier coatings derived from the compositions.

The dispersions are preferably concentrated after formulation and prior to application to a substrate, which surprisingly increases the barrier properties of the films produced.

The dispersions are readily converted into barrier films by conventional techniques and are processable much like conventional clay coatings.

Still further features and advantages of the invention are apparent from the following description.

### DETAILED DESCRIPTION OF THE INVENTION

The present invention is unique in that it provides for barrier coating compositions, films, and coated articles that achieve substantial reductions in gas permeability and/or permeation rate by providing a dispersion of hyperplaty kaolin and polyesters suitable for film-forming.

The results obtained with (non-elastomeric) polyesters are surprising, for example, when viewed relative to the relatively dilute elastomeric nanocomposite formulations of U.S. Pat. No. 6,087,016, “Barrier Coating of an Elastomer and a Dispersed Layered Filler in a Liquid Carrier” Jul. 11, 2000, to Feeney et al., or the relatively concentrated coating compositions of U.S. Pat. Nos. 7,208,039; 7,214,264 and 7,226,005 to Jones et al. The results are unexpected, in part, because aqueous dispersions of non-elastomeric polymers usually retain their spherical morphology through the process of forming a film from the aqueous dispersion. This means that one would expect it to be very difficult to get good dispersion of the platy or hyperplaty kaolin filler in the final coating, and one skilled in the art would expect that the filler would coalesce at the interfaces between the polymer particles during film formation. The large reductions in barrier properties that have been achieved indicate that this coalescence did not occur to a large enough extent to limit the reduction in permeability. Furthermore, the coatings formed from the compositions of this invention also retain the high opacity, characteristic of kaolin, thus exhibiting high gloss, smoothness and/or brightness of the material.

The invention is described in detail below for purposes of illustration only. Modifications within the spirit and scope of the invention, set forth in the appended claims, will be readily apparent to one of skill in the art. Unless defined otherwise, terminology and abbreviations, as used herein, have their ordinary meaning. Following are some exemplary definitions of terms used in this specification and the appended claims.

“Aqueous Dispersion” and like terminology refers to emulsions, latexes and stable suspensions of solids in water.

As used herein, the phrase “non-elastomeric polymer,” and like terminology, includes those polymeric materials with glass transition temperatures (T_{g}) around room temperature, i.e., 23° C., and/or with crystallinity above 10%.

The phrase “concentrated dispersion,” “concentrated composite dispersion,” or like terminology refers to a suspension, dispersion, emulsion, or slurry of kaolin and a matrix polymer in a liquid carrier medium, where the dispersion is concentrated by removal of a portion of the liquid carrier medium. The “liquid carrier medium” is generally water.

The term “composite” or “filled polymer composite” refers to the mixture of kaolin and polymer. The mean particle size of the filler particles, “d₅₀”, of at least some filler particles can be below 1 micron (1 micrometer or 1 μm), and even can be below 250 nm (0.25 micrometer or 0.25 μm).

The term “shape factor” as used herein is a measure of an average value (on a weight average basis) of the ratio of mean particle diameter to particle thickness for a population of particles of varying size and shape as measured using the electrical conductivity method, apparatus and equations described in U.S. Pat. No. 5,576,617, which is incorporated herein by reference in its entirety.

The term “platy” refers to hydrous kaolin clays with shape factors of greater than about 40:1 as well as “hyperplaty” clays which refers to kaolin clays with shape factors of greater than about 70:1.

The term “mean particle diameter” is defined as the diameter of a circle that has the same area as the largest face of the particle. The mean particle size, d₅₀ value, and other particle size properties referred to in the present application are measured in a well known manner by sedimentation of the particulate material in a fully dispersed condition in an aqueous medium using a SEDIGRAPH 5100 machine as supplied by Micromeritics Corporation. Such a machine provides measurements and a plot of the cumulative percentage by weight of particles having a size, referred to in the art as the “equivalent spherical diameter” (esd). The mean particle size d₅₀ is the value determined in this way of the particle esd at which there are 50 percent by weight of the particles that have an esd less than that d₅₀ value.

The “oxygen transmission rate,” or “OTR,” of the coatings used in the invention is measured according to ASTM D-3985-02 or any other suitable protocol using a MOCON® OXTRAN 2/21 or 2/61 module or Illinois Instrument 8001 or 8011 module and the following conditions: pressure of 1 atmosphere, a temperature of 23° C., and a relative humidity of 0 percent.

A “barrier coating composition” or “barrier coating mixture” includes a liquid containing suspended solids, which is used to apply the solids to a substrate. This includes a colloidal dispersion, suspension, emulsion and latex as they are conventionally defined. For example, by “colloidal dispersion or latex” is meant any dispersion or suspension of particles in liquid, the particles being of a size greater than molecular scale, e.g., about 0.001 to about 0.1 micron. An emulsion generally contains particles of about 0.05 to 1.0 microns, in liquid. A “suspension” generally contains particles of greater than 1.0 micron in liquid. A novel aspect of the present invention is that the barrier coating compositions provide a better dispersion of platy or hyperplaty kaolin functional additives in liquid at an unusually high solids content, e.g., between about 45 to about 60 percent solids as described in more detail below. According to this invention, once the “coating mixture” is dried, it is sometimes referred to as a “dried coating” or a “film”.

The term “gas barrier” includes a barrier to oxygen, nitrogen, carbon dioxide and other gases.

“Oxygen permeability,” as used herein, refers to a property of a material that describes the ease with which oxygen gas transmits through a film made of the material. The polyester-kaolin composite films of the present invention have an oxygen permeability that is at least 5 times less than that of like films (of the same thickness) which contain no kaolin filler.

It should be noted that water is used as a dispersing and/or a liquid carrier medium. However, various other liquids which are water miscible or water compatible can also be used in conjunction with water. Examples of such solvents include, without any limitation, various water miscible alcohols, ethanol being preferred, ketones such as acetone, methyl ethyl ketone, esters such as butyl acetate or ethyl acetates, and the like. Preferably no other solvent is used with water.

The coating formulations and subsequent polymer-kaolin barrier coatings that are formed from them are unique in the following respects among others:
1. The dispersed polymer used is not elastomeric—(surprising that the dispersed polymer particles can deform to form the hyperplaty barrier film);
2. The platy or hyperplaty kaolin additive has not been organically functionalized (which is typically done using an ion exchange process with organic cations);
3. The concentration of filler can be high (up to 70% relative to the total weight) also leading to large reductions in permeability and reduced drying costs.

Non-elastomeric polyesters suitably include those polyesters with T_{g} values less than 70° C., preferably less than 35° C. Polyethylene terephthaltate, polyethylene naphthalate, polyethylene bibenzoate and other partially aromatic and partially crystalline polyesters are especially suitable along with the other polyesters noted below.

The polyesters used in accordance with the practice of the present invention are generally obtained by known polymerization techniques from aliphatic or aromatic dicarboxylic acids with saturated aliphatic or aromatic diols. Preferred aromatic diacid monomers are the lower alkyl esters such as the dimethyl esters of terephthalic acid or isophthalic acid. Typical aliphatic dicarboxylic acids include adipic, sebacic, azelaic, dodecanedioic acid or 1,4-cyclohexanedicarboxylic acid. The preferred aromatic dicarboxylic acid or its ester or anhydride is esterified or trans-esterified and polycondensed with the saturated aliphatic or aromatic diol. Typical saturated aliphatic diols preferably include the lower alkane-diols such as ethylene glycol. Typical cycloaliphatic diols include 1,4-cyclohexane diol and 1,4-cyclohexane dimethanol. Typical aromatic diols include aromatic diols such as hydroquinone, resorcinol and the isomers of naphthalene diol (1,5-; 2,6-; and 2,7-). Various mixtures of aliphatic and aromatic dicarboxylic acids and saturated aliphatic and aromatic diols may also be used. Most typically, aromatic dicarboxylic acids are polymerized with aliphatic diols to produce polyesters, such as polyethylene terephthalate (terephthalic acid+ethylene glycol). Additionally, aromatic dicarboxylic acids can be polymerized with aromatic diols to produce wholly aromatic polyesters, such as polyphenylene terephthalate (terephthalic acid+hydroquinone). Some of these wholly aromatic polyesters form liquid crystalline phases in the melt and thus are referred to as “liquid crystal polyesters” or LCPs.

Also included are those polyesters containing A-B monomers. The polyesters described above are derived from what is known as A-A and B-B type monomers. That is, monomers that contain the same polymerizable group where it is either a diacid (terephthalic acid) or diol (ethylene glycol). However, polyesters can also be derived from what is known as A-B monomers, where there are two different polymerizable groups on each molecule. Examples of A-B monomers would include 4-hydroxy benzoic acid (HBA) and the various isomers of hydroxy naphthoic acid (HNA). These monomers could polymerize to form a homopolyester such as poly (HBA) or copolymerize with any A-A and/or B-B monomer.

Examples of polyesters include; polyethylene terephthalate; poly(1,4-butylene)terephthalate; and 1,4-cyclohexylene dimethylene terephthalate/isophthalate copolymer and other linear homopolymer esters derived from aromatic dicarboxylic acids, including isophthalic acid, bibenzoic acid, naphthalene-dicarboxylic acid including the 1,5-; 2,6-; and 2,7-naphthalene-dicarboxylic acids; 4,4,-diphenylene-dicarboxylic acid; bis(p-carboxyphenyl)methane acid; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid, and diols selected from the group consisting of 2,2-dimethyl-1,3-propane diol; cyclohexane dimethanol and aliphatic glycols of the general formula HO(CH₂)ₙOH where n is an integer from 2 to 10, e.g., ethylene glycol; 1,4-tetramethylene glycol; 1,6-hexamethylene glycol; 1,8-octamethylene glycol; 1,10-decamethylene glycol; and 1,3-propylene glycol; and polyethylene glycols of the general formula HO(CH₂CH₂O)ₙH where n is an integer from 2 to 10,000, and aromatic diols such as hydroquinone, resorcinol, bisphenol A, 4,4′-biphenol and the isomers of naphthalene diol (1,5-; 2,6-; and 2,7). There can also be present one or more aliphatic dicarboxylic acids, such as adipic, sebacic, azelaic, dodecanedioic acid or 1,4-cyclohexanedicarboxylic acid.

Also included are polyester containing polymers such as polyesteramides, polyesterimides, polyesteranhydrides, polyesterethers, polyesterketones and the like.

The polymer is supplied in the form of a dispersion, latex, suspension or emulsion in water, or a mixture of water with a solvent. The polymer can also be supplied in pellet form and dispersed in water. Suitable polymers are Eastman WD-30 and EASTEK 1000. Specifically exemplified below are coating mixtures of the invention employing these polymers.

Kaolin, also referred to as China Clay, or hydrous kaolin, is comprised predominantly of the mineral kaolinite, a hydrous aluminum silicate, together with small amounts of a variety of impurities. Particulate kaolin products find a variety of uses, including as pigments, fillers, and extenders for use in paint, plastics, polymers, and so forth.

Kaolin pigments confer desirable physical and optical properties to such compositions. As flattening (or matting) agents, they help smooth the surfaces of the substrates to which they are applied. As opacifiers, they impart brightness, whiteness, gloss and other desirable optical properties. As extenders, they allow partial replacement of titanium dioxide and other more expensive pigments with minimal loss of whiteness or brightness.

In particular and as it relates to this invention, coatings made from a variety of kaolins are applied to sheet materials for a number of purposes including, but not limited to, increasing the gloss, smoothness, opacity and/or brightness of the material. Coatings may also be applied to hide surface irregularities or in other ways improve the surface for the acceptance of print.

Hyperplaty kaolin that is suitable for use in the composition of this invention is described in U.S. Pat. Nos. 6,758,895; 7,208,039; 7,214,264 and 7,226,005, all of which are incorporated herein by reference in their entirety. Platy kaolin that is suitable for use in the composition of this invention is described in U.S. Pat. Nos. 6,616,749; 6,814,796; 6,537,363; 6,610,137; 6,564,199; and 6,808,559, all of which are incorporated herein by reference in their entirety. Briefly, the high shape factor may be achieved by grinding mined kaolinitic clays until the desired shape factor is achieved. Any art recognized grinding method can be used with the present invention including but not limited to, for example, wet grinding using sand or ceramic media. For example, the kaolin may be prepared by light comminution, e.g., grinding or milling, of a coarse kaolin to give suitable delamination thereof. The comminution may be carried out by use of beads or granules of a ceramic or plastic, e.g., nylon, grinding or milling aid. Appropriate grinding energies will be readily apparent and easily calculated by the skilled artisan. Significant grinding energies may be necessary to attain desirable high shape factors, however kaolin crude selected for its natural platyness will grind to high shape factors in an energy range typically used to manufacture standard delaminated kaolin pigments that have lesser shape factors.

Crude kaolin or a high shape factor product obtained from grinding or milling may be refined to remove impurities and improve physical properties using well known procedures generally referred to as beneficiation processes. The kaolin may be treated by a known particle size classification procedure, screening and/or centrifuging, to obtain particles having a desired particle size distribution and d₅₀ value (as discussed above). Preferably, mined clays are suitably first degritted before they are subjected to grinding to achieve the desired shape factor.

Kaolin samples developed and provided by Imerys Pigments Inc. (USA) and Imerys Minerals Ltd. (UK), discussed in the description of Examples, were tested and found suitable for the barrier coating composition of this invention.

The barrier coating formulations of the invention may employ at least one or more than one suitable surfactant to reduce surface tension, and aid in dispersion. Surfactants include materials otherwise known as wetting agents, anti-foaming agents, emulsifiers, dispersing agents, leveling agents etc. Surfactants can be anionic, cationic and nonionic, and many surfactants of each type are available commercially. A suitable surfactant for inclusion in these compositions possesses a critical micelle concentration sufficiently low to ensure a dried barrier coating uncompromised by residual surfactant. In the event of an unfavorable interaction of the anionic emulsifier present in the latex dispersion, additional ionic additives should be kept to a minimum. This variable is eliminated where the surfactant or emulsifier is non-ionic. Increase in ionic concentration of the compositions, such as by the addition of a base to adjust pH, e.g., KOH, NH₄OH and NaOH, may cause agglomeration of the filler, which adversely affects permeability reduction.

Desirable surfactants may include SURFYNOL® PSA 336 or SURFYNOL 104E (Air Products, Inc.), POLYSTEP B27 (Stepan Company), SILWET® L-77 (OSI Specialties, Inc.), and ZONYL FSP and 8952 (DuPont Performance Chemicals and Intermediates). The amount and number of surfactants added to the coating composition will depend on the particular surfactant(s) selected, but should be limited to the minimum amount of surfactant that is necessary to achieve wetting of the substrate while not compromising the performance of the dried barrier coating. For example, typical surfactant amounts can be less than or equal to about 15% by weight of the dried barrier coating.

It has now been found that use of at least one or more dispersants in the formulations of this invention dramatically improves the barrier properties of the films formed therefrom.

Other additives that are of particular use in the compositions of this invention are thickeners. Any of the art recognized thickeners can be used in this invention. A few of the examples of thickeners include without any limitation, a variety of polyethylene glycols and their copolymers as well as a variety of acrylic copolymers. Specific commercially available thickeners are sold under the name ACUSOL thickeners from Rohm & Haas, which also serve as opacifiers to brighten the compositions of this invention. Specific commercially available grades include ACUSOL 880, which is a PEG copolymer and ACUSOL 882 which is an acrylic copolymer. Both of these thickeners are also useful as nonionic associative rheology modifiers.

The dispersions may also include additional additives such as emulsifiers, biocides, colloidal dispersants, anti-foaming agents, dispersing agents, wetting agents, leveling agents, thickeners, absorbers and getters. Other optional components of the coating mixture include conventional agents to adjust pH, such as bases, e.g., NH₄OH, NaOH or KOH; or acids, e.g., acetic acid, citric acid or glycine provided that care is taken to avoid agglomeration.

In one embodiment of this invention, the aqueous barrier coating composition of this invention is concentrated by selectively evaporating off a portion of water in order to increase the total solids content at least by about 5 percent. Any art recognized concentration method can be used with the present invention including, but not limited to, for example, evaporation and/or condensation methods or distillation at atmospheric and/or below atmospheric pressure conditions. In a condensation approach, the composition is suitably subjected to an elevated temperature, so as to evaporate-off selectively a portion of water to increase the solids content of the dispersion. In a distillation method, the water is removed by distillation either under atmospheric pressure conditions or at reduced pressure at a lower temperature. Similarly, the formulation can also be subjected to the condensation step thereby a portion of water is removed selectively. The purpose is to selectively increase the solids content of the dispersion. The liquid may be evaporated off by heating; preferably at a temperature of from about 80° C. to about 100° C. for about 70 to about 100 minutes while stirring until about 1% to about 30% of the liquid carrier evaporates.

The dispersions are typically condensed such that the solids content of the dispersion increases by at 20 percent or even more preferably at least 30 percent or most preferably at least 50 percent. The concentrated dispersion generally includes at least about 25 weight percent solids, preferably from about 30 to about 70 weight percent solids. Before it is concentrated, the dispersion typically includes from about 15 to 20 weight percent solids. It is unexpected that the dispersion may be concentrated by evaporation without causing the formulation to gel. For example, many filler materials, such as kaolin, form gels at relatively low solids content, and the solids content of the silicate component often limits the final solids content of the barrier coating.

As noted above, the compositions of this invention can have a relatively high total solids content on a weight basis as compared with known nanocomposite barrier compositions and a relatively low solids content as compared with clay coating compositions.

After coating, the applied film mold may be dried at a selected temperature, e.g., room temperature or greater than room temperature. The selection of the drying temperature, relative humidity, and convective air flow rates depends on the desired time for drying; that is, reduced drying times may be achieved at elevated air temperatures, lower relative humidity and higher rates of air circulation over the drying coating surface. One of skill in the art can readily adjust the drying conditions as desired.

The dried coatings exhibit a surprising reduction in permeability compared to the prior art and particularly compared to unfilled polymers. As evidenced in the Examples below, reductions in permeability caused by the dried coatings of this invention are shown to be from about 5 fold to 20 fold and even higher relative to the unfilled polymers alone. The evaluation of gas permeability of the coatings of the present invention is further described in detail by specific Examples 1-30.

The coatings of the invention are particularly suitable for polymeric film substrates; or a blow-molded, thermoformed or injection molded container; and is used to package goods which are sensitive to gases such as oxygen, for example, food, drinks, electronic components, pharmaceuticals, biological materials, and the like.

### EXAMPLES

In the following examples, non-elastomeric polyester-kaolin barrier coating compositions are prepared and applied to suitable polyester (PET) or polypropylene (PP) film substrates and then are tested for oxygen transmission rate. The barrier coating dispersions are prepared in an aqueous medium with a polyester (EASTEK 1000, Eastman, 30% polymer solids) and kaolin clay samples (provided by Imerys) as the filler.

### Experimental Procedures

Oxygen Transmission Rate (OTR) Testing

Films and coated substrates are tested for oxygen transmission rate using a Mocon OXTRAN 2/21 or 2/61 module or Illinois Instrument 8001 or 8011 module at 23° C., 0% RH, and 1 atm. The samples are loaded onto the modules and conditioned for 2 hours prior to testing for oxygen. Once equilibrium is reached, an OTR is reported in units of cc/m² day atm.

### Thickness Measurements

All thickness calculations are based on the weight of the coating, and an assumed density. For the purposes of the present invention, the density for the polymer phase is assumed to be 1.2 gm/cc in all cases, even though it is recognized that each polymer has a different density. The density of the non-elastomeric polymer-kaolin composition was estimated using a rule of mixtures, and an assumed density of the clay of 2.6 gm/cc.

The thickness of the coating on a substrate is measured after the OTR is reported. Each sample is removed from the Mocon or Illinois Instrument module and a circle of specified size is cut from the sample. The cut circle is weighed. The weight of the coating is obtained from subtracting the weight of the uncoated circle, and the thickness calculated from the size of the circle and weight of the coating. For coating thickness less than 5 microns, the thickness is measured using an optical profilometer. The thickness of the film is reported in millimeters and used to calculate the permeability of the film.

The permeability of the coatings is calculated as follows:

$$Permeability of barrier coating = \frac{{X}_{1}}{[ ( 1 \text{/} OTR ) - ( {X}_{2} \text{/} {P}_{X 2} ) ]}$$

where X₁ is the barrier coating thickness; X₂ is substrate thickness, P_{X2} is permeability of the substrate, and OTR is oxygen transmission rate measured for the barrier coating. The reduction in permeability is calculated as follows:

$$Reduction in permeability = [ 1 - \frac{\begin{matrix}Permeability of a barrier \\ coating prepared according \\ to the inventive method\end{matrix}}{ \begin{matrix}Permeability of a barrier coating \\ prepared by other method\end{matrix}} ] \times 100 \%$$

The benefit of obtaining the permeability of the coating versus the OTR of the sample is that permeability reports the OTR at a specified thickness. Therefore, coatings with different thicknesses can be compared directly. OTR units are cc/m² day at 1 atmosphere, 0% relative humidity at 23° C. Permeability units are cc mm/m² day at 1 atmosphere, 0% relative humidity at 23° C.

### Examples 1-5

The following Examples 1-5 illustrate the oxygen barrier properties of the films formed from the coating composition in which kaolin acid treatment was adjusted for the various coating compositions. The results of Examples 1-5 are summarized in Table 1 below.

### Example 1

### NB#38764-49-2a

In a 4 oz jar with a stir bar, place 17.5 g of Kaolin clay (XP07-6140, Imerys, 30%) and 0.04 g of ACUMER 9300 (Rohm & Haas, 40%) and allow the clay to stir overnight resulting in 30% slurry of Kaolin.

In an 8 oz jar with a stir bar, place 20.35 g of de-ionized water, 0.28 g of ACUSOL 880 (Rohm & Haas, 35.2%) and 0.55 g of ACUSOL 882 (Rohm & Haas, 17.7%) and stir overnight. To this solution, add 31.32 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 37% solids.

The solution is hand coated on 92 ga BOPP film using a #15 mayer rod and air dried. The coated film resulted in an oxygen transmission rate of 58 cc/m2 day atm @ 23° C. and 0% relative humidity and a permeability of the 3.6 micron film is 0.22 cc mm/m2 day atm @ 23° C. and 0% relative humidity. This permeability is reduced from the unfilled polymer by 10.5 times.

### Example 2

### NB#38764-24-1

In a 4 oz jar with a stir bar, place 17.5 g of Kaolin clay (XP6100DF, Imerys, 30%) and 0.04 g of ACUMER 9300 (Rohm & Haas, 40%) and stir overnight resulting in 30% slurry of Kaolin. To the resulting slurry, add 2.79 g of glycine (Hawk Creek Laboratories, 20%) and stir for 60 minutes.

In an 8 oz jar with a stir bar, place 24.39 g of de-ionized water, 0.26 g of ACUSOL 880 (Rohm & Haas, 35.2%) and 0.52 g of ACUSOL 882 (Rohm & Haas, 17.7%) and stir overnight. To this solution, add 29.54 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 42% solids.

The solution is hand coated on 92 ga PET film using a #15 mayer rod and air dried. The coated film resulted in an oxygen transmission rate of 24.4 cc/m2 day atm @ 23° C. and 0% relative humidity and a permeability of the 4.1 micron film is 0.20 cc mm/m2 day atm @ 23° C. and 0% relative humidity. This permeability is reduced from the unfilled polymer by 11.5 times.

### Example 3

### NB#38764-14-3

In a 4 oz jar with a stir bar, place 22.42 g of Kaolin clay (XP6100, 19.9%, Imerys). To the stirring slurry, add 7.13 g of glycine (Hawk Creek Laboratories, 20%) and stir for 60 minutes.

In an 8 oz jar with a stir bar, place 22.82 g of de-ionized water, 0.19 g of ACUSOL 880 (Rohm & Haas, 35.2%) and 0.39 g of ACUSOL 882 (Rohm & Haas, 17.7%) and stir overnight. To this solution, add 22.05 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, %) and stir for 15 minutes.

The resulting formulation is then heated uncovered in a water bath with an internal temperature of 75-80° C. until the desired solids is reached. The concentrated solution is cooled while stirring resulting in 32% solids.

The solution is hand coated on 92 ga PET film using a #15 mayer rod and air dried. The coated film resulted in an oxygen transmission rate of 23.3 cc/m2 day atm @ 23° C. and 0% relative humidity and a permeability of the 3.1 micron film is 0.14 cc mm/m2 day atm @ 23° C. and 0% relative humidity. This permeability is reduced from the unfilled polymer by 16.4 times.

### Example 4

### NB#38764-52-2

In a 4 oz jar with a stir bar, place 17.5 g of Kaolin clay (XP01-6100, Imerys, 30%) and 8.39 g of glycine (Hawk Creek Laboratories, 20%) and stir for 24 hours resulting in a 30% slurry.

In an 8 oz jar with a stir bar, place 22.52 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 49% solids.

The solution is hand coated on 92 ga BOPP film using a #15 mayer rod and air dried. The coated film resulted in an oxygen transmission rate of 15.8 cc/m2 day atm @ 23° C. and 0% relative humidity and a permeability of the 4.8 micron film is 0.11 cc mm/m2 day atm @ 23° C. and 0% relative humidity. This permeability is reduced from the unfilled polymer by 20.9 times.

### Example 5

### NB#38764-10-2a

In a 4 oz jar with a stir bar, place 26.38 g of Kaolin clay (XP6100, 19.9%, Imerys). To the stirring slurry, add 13.96 g of acetic acid (Fisher Scientific, 20%) and stir for 60 minutes.

In an 8 oz jar with a stir bar, place 11.72 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.35 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 35% solids.

The solution is hand coated on 92 ga PET film using a #15 mayer rod and air dried. The coated film resulted in an oxygen transmission rate of 28.4 cc/m2 day atm @ 23° C. and 0% relative humidity and a permeability of the 3.4 micron film is 0.24 cc mm/m2 day atm @ 23° C. and 0% relative humidity. This permeability is reduced from the unfilled polymer by 9.6 times.

TABLE 1
Adjust Kaolin Treatment

| | | | | | | Barrier | | |
|---|---|---|---|---|---|---|---|---|
| | Treatment | | | | Thick- | Properties | | |
| Exam- | | A- | | Film | ness | | Perme- | |
| ples | Type | mount | Time | 92 ga | microns | OTR | ability | X Redn |
| 1 | None | | | PP | 3.6 | 58 | 0.22 | 10.5 |
| 2 | Gly- | 1x | 60 | PET | 4.1 | 24.4 | 0.2 | 11.5 |
| | cine | | min | | | | | |
| 3 | Gly- | 3x | 60 | PET | 3.1 | 23.3 | 0.14 | 16.4 |
| | cine | | min | | | | | |
| 4 | Gly- | 3x | 24 | PP | 4.8 | 15.8 | 0.11 | 20.9 |
| | cine | | hr | | | | | |
| 5 | acetic | 5x | 60 | PET | 3.4 | 28.4 | 0.24 | 9.6 |
| | | | min | | | | | |

Notes:
Examples 1-5
Polymer phase is Eastek 1000.
Thickeners ACUSOL 880 and ACUSOL 882 at 1.0% levels.
All formulations made at 20% solids and concentrated to 32-49% solids.
OTR is oxygen transmission rate in units of cc/m2 day atm @ 23° C., 0% RH.
Permeability is oxygen permeability in units of cc mm/m2 day atm @ 23° C., 0% RH.
Times reduction is compared to the permeability of unfilled Eastek 1000 of 2.3 cc mm/m2 day atm @ 23° C., 0% RH.

It is seen in Table 1 that the barrier properties of the compositions can be greatly enhanced by the judicious choice of acid treatment.

### Examples 6-19

The following Examples 6-19 illustrate the compositions made according to this invention wherein dispersant levels on the kaolin clay are adjusted in order to obtain improved barrier properties. In the following Table 2A there is provided information on dispersants.

TABLE 2A
Dispersants

| Dispersant | Type | |
|---|---|---|
| ACUMER | Hydrophilic ionic | Sodium polyacrylate |
| 9300 | | |
| Colloid 102 | Hydrophilic ionic | Ammonium polyacrylate |
| | Sodium free | |
| Solsplus D540 | Hydrophilic non-ionic | |
| ACUSOL | Hydrophobic ionic | Polycarboxylate |
| 460N | | |
| TSPP | Inorganic | Tetra sodium pyrophosphate |
| PSS | Hydrophilic acid stable | Poly (sodium) styrene sulfonate |

### Example 6

### NB#38764-15-2

In a 4 oz jar with a stir bar, place 17.5 g of Kaolin clay (XP6100DF, Imerys, 30%) and 8.39 g of glycine (Hawk Creek Laboratories, 20%) and stir for 60 minutes resulting in a 30% slurry of Kaolin.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 46% solids.

The solution is hand coated on 92 ga PET film using a #15 mayer rod and air dried. The coated film resulted in an oxygen transmission rate of 22.5 cc/m2 day atm @ 23° C. and 0% relative humidity and a permeability of the 4.5 micron film is 0.19 cc mm/m2 day atm @ 23° C. and 0% relative humidity. This permeability is reduced from the unfilled polymer by 12.1 times.

### Example 7

### NB#38764-16-1

In a 4 oz jar with a stir bar, place 17.5 g of Kaolin clay (XP6100DF, Imerys, 30%) and 0.05 g of PSS (Sigma-Aldrich, 30%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 32% solids.

The solution is hand coated on 92 ga PET film using a #15 mayer rod and air dried. The coated film resulted in an oxygen transmission rate of 29.7 cc/m2 day atm @ 23° C. and 0% relative humidity and a permeability of the 3.1 micron film is 0.27 cc mm/m2 day atm @ 23° C. and 0% relative humidity. This permeability is reduced from the unfilled polymer by 8.5 times.

### Example 8

### NB#38764-16-2

In a 4 oz jar with a stir bar, place 17.5 g of Kaolin clay (XP6100DF, Imerys, 30%) and 0.04 g of Colloid 102 (Kemira Chemicals, 41%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 32% solids.

The solution is hand coated on 92 ga PET film using a #15 mayer rod and air dried. The coated film resulted in an oxygen transmission rate of 27.2 cc/m2 day atm @ 23° C. and 0% relative humidity and a permeability of the 3.1 micron film is 0.19 cc mm/m2 day atm @ 23° C. and 0% relative humidity. This permeability is reduced from the unfilled polymer by 12.1 times.

### Example 9

### NB#38764-16-3

In a 4 oz jar with a stir bar, place 17.5 g of Kaolin clay (XP6100DF, Imerys, 30%) and 0.02 g of Solsplus D560 (Avecia Additives, 100%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 38% solids.

The solution is hand coated on 92 ga PET film using a #15 mayer rod and air dried. The coated film resulted in an oxygen transmission rate of 25.8 cc/m2 day atm @ 23° C. and 0% relative humidity and a permeability of the 3.7 micron film is 0.21 cc mm/m2 day atm @ 23° C. and 0% relative humidity. This permeability is reduced from the unfilled polymer by 11.0 times.

### Example 10

### NB#38764-17-1

In a 4 oz jar with a stir bar, place 17.5 g of Kaolin clay (XP6100DF, Imerys, 30%) and 0.04 g of ACUMER 9300 (Rohm & Haas, 44%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 41% solids.

The solution is hand coated on 92 ga PET film using a #15 mayer rod and air dried. The coated film resulted in an oxygen transmission rate of 20.4 cc/m2 day atm @ 23° C. and 0% relative humidity and a permeability of the 4.0 micron film is 0.14 cc mm/m2 day atm @ 23° C. and 0% relative humidity. This permeability is reduced from the unfilled polymer by 16.4 times.

### Example 11

### NB#38764-17-2

In a 4 oz jar with a stir bar, place 17.5 g of Kaolin clay (XP6100DF, Imerys, 30%) and 0.06 g of ACUSOL 460N (Rohm & Haas, 24%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 37% solids.

The solution is hand coated on 92 ga PET film using a #15 mayer rod and air dried. The coated film resulted in an oxygen transmission rate of 29.6 cc/m2 day atm @ 23° C. and 0% relative humidity and a permeability of the 3.6 micron film is 0.29 cc mm/m2 day atm @ 23° C. and 0% relative humidity. This permeability is reduced from the unfilled polymer by 14.4 times.

### Example 12

### NB#38764-17-3

In a 4 oz jar with a stir bar, place 17.5 g of Kaolin clay (XP6100DF, Imerys, 30%) and 0.02 g of TSPP (Chem Ace Chemical Supply, 100%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 41% solids.

The solution is hand coated on 92 ga PET film using a #15 mayer rod and air dried. The coated film resulted in an oxygen transmission rate of 30.3 cc/m2 day atm @ 23° C. and 0% relative humidity and a permeability of the 4.0 micron film is 0.33 cc mm/m2 day atm @ 23° C. and 0% relative humidity. This permeability is reduced from the unfilled polymer by 7.0 times.

### Example 13

### NB#38764-18-1

In a 4 oz jar with a stir bar, place 17.5 g of Kaolin clay (XP6100DF, Imerys, 30%) and 0.05 g of Dispex HDN (Rohm & Haas, 24%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 40% solids.

The solution is hand coated on 92 ga PET film using a #15 mayer rod and air dried. The coated film resulted in an oxygen transmission rate of 30.5 cc/m2 day atm @ 23° C. and 0% relative humidity and a permeability of the 3.9 micron film is 0.33 cc mm/m2 day atm @ 23° C. and 0% relative humidity. This permeability is reduced from the unfilled polymer by 7.0 times.

### Example 14

### NB#38764-19-3

In a 4 oz jar with a stir bar, place 17.5 g of Kaolin clay (XP6100DF, Imerys, 30%) and 0.065 g of ACUMER 9300 (Rohm & Haas, 44%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 36% solids.

The solution is hand coated on 92 ga PET film using a #15 mayer rod and air dried. The coated film resulted in an oxygen transmission rate of 33.5 cc/m2 day atm @ 23° C. and 0% relative humidity and a permeability of the 3.5 micron film is 0.39 cc mm/m2 day atm @ 23° C. and 0% relative humidity. This permeability is reduced from the unfilled polymer by 5.9 times.

### Example 15

### NB#38764-20-1

In a 4 oz jar with a stir bar, place 17.5 g of Kaolin clay (XP6100DF, Imerys, 30%) and 0.11 g of ACUSOL 460N (Rohm & Haas, 24%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 36% solids.

The solution is hand coated on 92 ga PET film using a #15 mayer rod and air dried. The coated film resulted in an oxygen transmission rate of 32.7 cc/m2 day atm @ 23° C. and 0% relative humidity and a permeability of the 3.4 micron film is 0.35 cc mm/m2 day atm @ 23° C. and 0% relative humidity. This permeability is reduced from the unfilled polymer by 6.6 times.

### Example 16

### NB#38764-20-2

In a 4 oz jar with a stir bar, place 35.0 g of Kaolin clay (XP6100DF, Imerys) and 0.03 g of ACUMER 9300 (Rohm & Haas, 44%) and stir overnight resulting in 30% slurry of Kaolin. To the resulting slurry, add 16.77 g of glycine (Hawk Creek Laboratories, 20%) and stir for 60 minutes.

In an 8 oz jar with a stir bar, place 44.97 g of de-ionized water, 0.46 g of ACUSOL 880 (Rohm & Haas, 35.2%) and 0.92 g of ACUSOL 882 (Rohm & Haas, 17.7%) and stir overnight. To this solution, add 51.88 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 38% solids.

The solution is hand coated on 92 ga PET film using a #15 mayer rod and air dried. The coated film resulted in an oxygen transmission rate of 30.9 cc/m2 day atm @ 23° C. and 0% relative humidity and a permeability of the 3.7 micron film is 0.32 cc mm/m2 day atm @ 23° C. and 0% relative humidity. This permeability is reduced from the unfilled polymer by 7.2 times.

### Example 17

### NB#38764-20-3

In a 4 oz jar with a stir bar, place 35.0 g of Kaolin clay (XP6100DF, Imerys, 30%) and 0.04 g of ACUSOL 460N (Rohm & Haas, 24%) and stir overnight resulting in 30% slurry of Kaolin. To the resulting slurry, add 16.77 g of glycine (Hawk Creek Laboratories, 20%) and stir for 60 minutes.

In an 8 oz jar with a stir bar, place 44.97 g of de-ionized water, 0.46 g of ACUSOL 880 (Rohm & Haas, 35.2%) and 0.92 g of ACUSOL 882 (Rohm & Haas, 17.7%) and stir overnight. To this solution, add 51.88 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 41% solids.

The solution is hand coated on 92 ga PET film using a #15 mayer rod and air dried. The coated film resulted in an oxygen transmission rate of 29.7 cc/m2 day atm @ 23° C. and 0% relative humidity and a permeability of the 4.0 micron film is 0.31 cc mm/m2 day atm @ 23° C. and 0% relative humidity. This permeability is reduced from the unfilled polymer by 7.4 times.

### Example 18

### NB#38764-21-3

In a 4 oz jar with a stir bar, place 17.5 g of Kaolin clay (XP6100DF, Imerys, 30%) and 0.03 g of ACUMER 9300 (Rohm & Haas, 44%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 43% solids.

The solution is hand coated on 92 ga PET film using a #15 mayer rod and air dried. The coated film resulted in an oxygen transmission rate of 28.2 cc/m2 day atm @ 23° C. and 0% relative humidity and a permeability of the 4.2 micron film is 0.33 cc mm/m2 day atm @ 23° C. and 0% relative humidity. This permeability is reduced from the unfilled polymer by 7.0 times.

### Example 19

### NB#38764-22-1

In a 4 oz jar with a stir bar, place 17.5 g of Kaolin clay (XP6100DF, Imerys, 30%) and 0.04 g of ACUSOL 460N (Rohm & Haas, 24%) and stir overnight resulting in 30% slurry of Kaolin. To the resulting slurry, add 8.39 g of glycine (Hawk Creek Laboratories, 20%) and stir for 60 minutes.

In an 8 oz jar with a stir bar, place 22.48 g of de-ionized water, 0.23 g of ACUSOL 880 (Rohm & Haas, 35.2%) and 0.46 g of ACUSOL 882 (Rohm & Haas, 17.7%) and stir overnight. To this solution, add 25.94 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 41% solids.

The solution is hand coated on 92 ga PET film using a #15 mayer rod and air dried. The coated film resulted in an oxygen transmission rate of 24.5 cc/m2 day atm @ 23° C. and 0% relative humidity and a permeability of the 4.0 micron film is 0.21 cc mm/m2 day atm @ 23° C. and 0% relative humidity. This permeability is reduced from the unfilled polymer by 11.0 times.

The results of Examples 6-19 are summarized in Table 2B below.

TABLE 2B
Adjust Dispersant Level on Kaolin

| | Dispersant | | Thick- | Barrier Properties | | |
|---|---|---|---|---|---|---|
| Ex- | | A- | ness | | Perme- | X |
| amples | Type | mount | microns | OTR | ability | Redn |
| 6 | Contol | 0 | 4.5 | 22.5 | 0.19 | 12.1 |
| 7 | PSS | 0.3 | 3.1 | 29.7 | 0.27 | 8.5 |
| 8 | Colloid 102 | 0.3 | 3.1 | 27.2 | 0.19 | 12.1 |
| 9 | Solsplus D560 | 0.3 | 3.7 | 25.8 | 0.21 | 11.0 |
| 10 | ACUMER 9300 | 0.3 | 4.0 | 20.4 | 0.14 | 16.4 |
| 11 | ACUSOL 460N | 0.3 | 3.9 | 22.3 | 0.16 | 14.4 |
| 12 | TSPP | 0.3 | 4 | 30.3 | 0.33 | 7.0 |
| 13 | Dispex HDN | 0.3 | 3.9 | 30.5 | 0.33 | 7.0 |
| 14 | ACUMER 9300 | 0.5 | 3.5 | 33.5 | 0.39 | 5.9 |
| 15 | ACUSOL 460N | 0.5 | 3.4 | 32.7 | 0.35 | 6.6 |
| 16 | ACUMER 9300 | 0.1 | 3.7 | 30.9 | 0.32 | 7.2 |
| 17 | ACUSOL 460N | 0.1 | 4 | 29.7 | 0.31 | 7.4 |
| 18 | ACUMER 9300 | 0.2 | 4.2 | 28.2 | 0.33 | 7.0 |
| 19 | ACUSOL 460N | 0.2 | 4 | 24.5 | 0.21 | 11.0 |

Notes:
Examples 6-19
All films on 92 ga PET
Polymer phase is Eastek 1000.
Clay treatment 3x of 20% glycine for 60 minutes.
Thickeners ACUSOL 880 and ACUSOL 882 at 1.0% levels.
All formulations made at 20% solids and concentrated to 35-45% solids.
Clay used was XP6100DF without dispersant and disperant added into 30% slurry and stirred for 24 hours.
OTR is oxygen transmission rate in units of cc/m2 day atm @ 23° C., 0% RH.
Permeability is oxygen permeability in units of cc mm/m2 day atm @ 23° C., 0% RH.
Times reduction is compared to the permeability of unfilled Eastek 1000 of 2.3 cc mm/m2 day atm @ 23° C., 0% RH.

It is seen in Table 2B that barrier properties can be enhanced by selection and use of dispersant in preferred levels.

### Examples 20-26

Examples 20-26 demonstrate the effects of using different grades of kaolin which results in different barrier properties. Specifics appear in Table 3. Here it is seen that the selection of a preferred clay enhances barrier properties.

### Example 20

### NB#38764-10-3

In a 4 oz jar with a stir bar, place 26.78 g of Kaolin clay (Sample #1, 19.9%, Imerys). To the stirring slurry, add 13.96 g of acetic acid (Fisher Scientific, 20%) and stir for 60 minutes.

In an 8 oz jar with a stir bar, place 11.3 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.35 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 35% solids.

The solution is hand coated on 92 ga PET film using a #15 mayer rod and air dried. The coated film resulted in an oxygen transmission rate of 33.3 cc/m2 day atm @ 23° C. and 0% relative humidity and a permeability of the 3.4 micron film is 0.37 cc mm/m2 day atm @ 23° C. and 0% relative humidity. This permeability is reduced from the unfilled polymer by 6.2 times.

### Example 21

### NB#38764-11-1

In a 4 oz jar with a stir bar, place 27.0 g of Kaolin clay (Sample #2, 19.9%, Imerys). To the stirring slurry, add 13.96 g of acetic acid (Fisher Scientific, 20%) and stir for 60 minutes.

In an 8 oz jar with a stir bar, place 11.1 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.35 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 30% solids.

The solution is hand coated on 92 ga PET film using a #15 mayer rod and air dried. The coated film resulted in an oxygen transmission rate of 42.6 cc/m2 day atm @ 23° C. and 0% relative humidity and a permeability of the 2.8 micron film is 1.06 cc mm/m2 day atm @ 23° C. and 0% relative humidity. This permeability is reduced from the unfilled polymer by 2.2 times.

### Example 22

### NB#38764-12-3

In a 4 oz jar with a stir bar, place 26.38 g of Kaolin clay (Sample #3, Imerys, 20%) and 13.96 g of acetic acid (Fisher Scientific, 20%) and stir for 60 minutes resulting in a 30% slurry of Kaolin.

In an 8 oz jar with a stir bar, place 11.72 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.35 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 37% solids.

The solution is hand coated on 92 ga PET film using a #15 mayer rod and air dried. The coated film resulted in an oxygen transmission rate of 38.4 cc/m2 day atm @ 23° C. and 0% relative humidity and a permeability of the 3.6 micron film is 0.69 cc mm/m2 day atm @ 23° C. and 0% relative humidity. This permeability is reduced from the unfilled polymer by 3.3 times.

### Example 23

### NB#38764-13-1

In a 4 oz jar with a stir bar, place 26.38 g of Kaolin clay (Sample #4, Imerys, 20%) and 13.96 g of acetic acid (Fisher Scientific, 20%) and stir for 60 minutes.

In an 8 oz jar with a stir bar, place 11.72 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.35 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 40% solids.

The solution is hand coated on 92 ga PET film using a #15 mayer rod and air dried. The coated film resulted in an oxygen transmission rate of 34.0 cc/m2 day atm @ 23° C. and 0% relative humidity and a permeability of the 3.8 micron film is 0.44 cc mm/m2 day atm @ 23° C. and 0% relative humidity. This permeability is reduced from the unfilled polymer by 5.2 times.

### Example 24

### NB#38764-13-2

In a 4 oz jar with a stir bar, place 26.38 g of Kaolin clay (Sample #5, Imerys, 20%) and 13.96 g of acetic acid (Fisher Scientific, 20%) and stir for 60 minutes.

In an 8 oz jar with a stir bar, place 11.72 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.35 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 31% solids.

The solution is hand coated on 92 ga PET film using a #15 mayer rod and air dried. The coated film resulted in an oxygen transmission rate of 39.3 cc/m2 day atm @ 23° C. and 0% relative humidity and a permeability of the 3.0 micron film is 0.65 cc mm/m2 day atm @ 23° C. and 0% relative humidity. This permeability is reduced from the unfilled polymer by 3.5 times.

### Example 25

### NB#38764-13-3

In a 4 oz jar with a stir bar, place 14.1 g of Kaolin clay (XP6100 (dry), Imerys, 56%) and 20.9 g of acetic acid (Fisher Scientific, 20%) and stir for 60 minutes.

In an 8 oz jar with a stir bar, place 5.58 g of de-ionized water, 0.30 g of ACUSOL 880 (Rohm & Haas, 35.2%) and 0.59 g of ACUSOL 882 (Rohm & Haas, 17.7%) and stir overnight. To this solution, add 33.53 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes. The final formulation has 25% solids.

The solution is hand coated on 92 ga PET film using a #15 mayer rod and air dried. The coated film resulted in an oxygen transmission rate of 35.4 cc/m2 day atm @ 23° C. and 0% relative humidity and a permeability of the 2.4 micron film is 0.32 cc mm/m2 day atm @ 23° C. and 0% relative humidity. This permeability is reduced from the unfilled polymer by 7.2 times.

### Example 26

### NB#38764-15-1

In a 4 oz jar with a stir bar, place 17.5 g of Kaolin clay (XP6100DF, Imerys, 30%) and 14.0 g of acetic acid (Fisher Scientific, 20%) and stir for 60 minutes.

In an 8 oz jar with a stir bar, place 20.58 g of de-ionized water, 0.20 g of ACUSOL 880 (Rohm & Haas, 35.2%) and 0.39 g of ACUSOL 882 (Rohm & Haas, 17.7%) and stir overnight. To this solution, add 22.33 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 29% solids.

The solution is hand coated on 92 ga PET film using a #15 mayer rod and air dried. The coated film resulted in an oxygen transmission rate of 37.8 cc/m2 day atm @ 23° C. and 0% relative humidity and a permeability of the 2.8 micron film is 0.50 cc mm/m2 day atm @ 23° C. and 0% relative humidity. This permeability is reduced from the unfilled polymer by 4.6 times.

The results of Examples 20-26 are summarized in Table 3. For comparison Example 5 is also included in this Table.

TABLE 3
Adjust Kaolin Type

| | | | | Barrier Properties | | |
|---|---|---|---|---|---|---|
| | Clay | | Thick- | | | X |
| | Design- | % | ness | | Perme- | Reduc- |
| Examples | ation | slurry | microns | OTR | ability | tion |
| 5 | XP6100 | 19.9 | 3.4 | 28.4 | 0.24 | 9.6 |
| 20 | Sample #1 | 19.9 | 3.4 | 33.3 | 0.37 | 6.2 |
| 21 | Sample #2 | 19.9 | 2.8 | 42.6 | 1.06 | 2.2 |
| 22 | Sample #3 | 20 | 3.6 | 38.4 | 0.69 | 3.3 |
| 23 | Sample #4 | 20 | 3.8 | 34 | 0.44 | 5.2 |
| 24 | Sample #5 | 20 | 3.0 | 39.3 | 0.65 | 3.5 |
| 25 | XP6100(dry) | 56 | 2.4 | 35.4 | 0.32 | 7.2 |
| 26 | XP6100DF | 30 | 2.8 | 37.8 | 0.5 | 4.6 |

| Clay | Description |
|---|---|
| XP6100 | Fine clay, 90-100 shape factor, |
| | dispersed with 0.3% sodium polyacrylate |
| Sample #1 | coarse clay, 60 shape factor, |
| | dispersed with 0.3% sodium polyacrylate |
| Sample #2 | medium clay, 70 shape factor, |
| | dispersed with 0.3% sodium polyacrylate |
| Sample #3 | Extra fine with 0.3% sodium polyacrylate |
| Sample #4 | Fine with 0.3% sodium polyacrylate |
| Sample #5 | Medium fine with 0.3% sodium polyacrylate |
| XP6100 | Same size/shape as XP6100 with 0.3% |
| (dry) | sodium polyacrylate in dry form |
| XP6100DF | Same size/shape as XP6100 with no dispersant |
| | in dry form |

Notes:
Examples 5, 20-26.
Polymer phase is Eastek 1000.
Clay treatment 5x of 20% acetic acid for 60 minutes.
Thickeners ACUSOL 880 and ACUSOL 882 at 1.0% levels.
All formulations made at 20% solids and concentrated to 35-45% solids.
All films were made on PET 92 ga film.
OTR is oxygen transmission rate in units of cc/m2 day atm @ 23° C., 0% RH.
Permeability is oxygen permeability in units of cc mm/m2 day atm @ 23° C., 0% RH.
Times reduction is compared to the permeability of unfilled Eastek 1000 of 2.3 cc mm/m2 day atm @ 23° C., 0% RH.

### Control Examples 27-29 and Example 30

The following Examples 27-30 demonstrate the effects of the formulation without concentration step and also illustrate the effects of solids content on the film forming capabilities of the formulations obtained therefrom. In Example 30, the concentration step was included to show the dramatic shift in the properties of the resulting formulation.

### Example 27

### NB#38764-07-1

In a 4 oz jar with a stir bar, place 8.11 g of Kaolin clay (Sample #2, 19.9%, Imerys) and 25.0 g of de-ionized water. To the stirring slurry, add 2.52 g of glycine (Hawk Creek Laboratories, 20%) and stir for 60 minutes.

In an 8 oz jar with a stir bar, place 31.4 g of de-ionized water, 0.03 g of ACUSOL 880 (Rohm & Haas, 35.2%) and 0.07 g of ACUSOL 882 (Rohm & Haas, 17.7%) and stir overnight. To this solution, add 7.87 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes. The resulting formulation contains 6% solids.

The solution could not be coated since the Kaolin clay settled immediately and could not be re-dispersed.

### Example 28

### NB#38764-07-2

In a 4 oz jar with a stir bar, place 13.2 g of Kaolin clay (XP6100, 19.9%, Imerys) and 25.0 g of de-ionized water. To the stirring slurry, add 4.19 g of glycine (Hawk Creek Laboratories, 20%) and stir for 60 minutes.

In an 8 oz jar with a stir bar, place 19.34 g of de-ionized water, 0.06 g of ACUSOL 880 (Rohm & Haas, 35.2%) and 0.11 g of ACUSOL 882 (Rohm & Haas, 17.7%) and stir overnight. To this solution, add 13.1 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes. The resulting formulation contains 10% solids.

The solution could not be coated since the Kaolin clay settled immediately and could not be re-dispersed.

### Example 29

### NB#38764-08-3

In a 4 oz jar with a stir bar, place 26.4 g of Kaolin clay (XP6100, 19.9%, Imerys) and 2.7 g de-ionized water. To the stirring slurry, add 8.4 g of glycine (Hawk Creek Laboratories, 20%) and stir for 60 minutes.

In an 8 oz jar with a stir bar, place 5.2 g of de-ionized water, 0.43 g of ACUSOL 880 (Rohm & Haas, 35.2%) and 0.85 g of ACUSOL 882 (Rohm & Haas, 17.7%) and stir overnight. To this solution, add 31.0 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes. The resulting formulation contained 20% solids.

The solution is hand coated on 92 ga PET film using a #15 mayer rod and air dried. The coated film resulted in an oxygen transmission rate of 40.3 cc/m2 day atm @ 23° C. and 0% relative humidity and a permeability of the 2.0 micron film is 0.50 cc mm/m2 day atm @ 23° C. and 0% relative humidity. This permeability is reduced from the unfilled polymer by 4.6 times.

### Example 30

### NB#38764-08-3a

In a 4 oz jar with a stir bar, place 26.4 g of Kaolin clay (XP6100, 19.9%, Imerys) and 2.7 g de-ionized water. To the stirring slurry, add 8.4 g of glycine (Hawk Creek Laboratories, 20%) and stir for 60 minutes.

In an 8 oz jar with a stir bar, place 5.2 g of de-ionized water, 0.43 g of ACUSOL 880 (Rohm & Haas, 35.2%) and 0.85 g of ACUSOL 882 (Rohm & Haas, 17.7%) and stir overnight. To this solution, add 31.0 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The resulting formulation is then heated uncovered in a water bath with an internal temperature of 75-80° C. until the desired solids is reached. The concentrated solution is cooled while stirring resulting in 37% solids.

The solution is hand coated on 92 ga PET film using a #15 mayer rod and air dried. The coated film resulted in an oxygen transmission rate of 31.6 cc/m2 day atm @ 23° C. and 0% relative humidity and a permeability of the 3.5 micron film is 0.32 cc mm/m2 day atm @ 23° C. and 0% relative humidity. This permeability is reduced from the unfilled polymer by 7.2 times.

The results of Examples 27-30 are summarized in Table 4 below.

TABLE 4
Adjust Solid Content of Formation

| | Solid | | | | Barrier Properties | |
|---|---|---|---|---|---|---|
| | Content % | | Thickness | | Perme- | X |
| Examples | Initial | Final | microns | OTR | ability | Reduction |
| 27 | 6 | 6 | No film | | | |
| 28 | 10 | 10 | No film | | | |
| 29 | 20 | 20 | 2.0 | 40.3 | 0.5 | 4.6 |
| 30 | 20 | 37 | 3.5 | 31.6 | 0.32 | 7.2 |

Notes:
Examples 27-30
Polymer phase is Eastek 1000.
Kaolin (XP6100) treatment 3x of 20% glycine for 60 minutes.
Thickeners ACUSOL 880 and ACUSOL 882 at 1.0% levels.
All films were made on PET 92 ga film.
OTR is oxygen transmission rate in units of cc/m2 day atm @ 23° C., 0% RH.
Permeability is oxygen permeability in units of cc mm/m2 day atm @ 23° C., 0% RH.
Times reduction is compared to the permeability of unfilled Eastek 1000 of 2.3 cc mm/m2 day atm @ 23° C., 0% RH.

### Example 31

### NB#38764-13-3

This Example shows that at higher concentration, less barrier is achieved than in cases where the formulation is concentrated prior to application to the substrate.

In a 4 oz jar with a stir bar, place 14.1 g of Kaolin clay (XP6100 (dry), 56%, Imerys). To the stirring slurry, add 20.9 g of acetic acid (Fisher Scientific, 20%) and stir for 60 minutes.

In an 8 oz jar with a stir bar, place g of de-ionized water, 0.3 g of ACUSOL 880 (Rohm & Haas, 35.2%) and 0.59 g of ACUSOL 882 (Rohm & Haas, 17.7%) and stir overnight. To this solution, add 33.53 g of Eastek 1000 (Eastman Chemicals, 30.2%). After 30 minutes of stirring, add the Kaolin slurry to the polymer mixture. To the resulting solution, add 0.04 g of Surfynol PSA-336 (Air Products, 100%) and stir for 15 minutes.

The solution is hand coated on 92 ga PET film using a #15 mayer rod and air dried. The coated film resulted in an oxygen transmission rate of 38.7 cc/m2 day atm @ 23° C. and 0% relative humidity and a permeability of the 2.4 micron film is 0.48 cc mm/m2 day atm @ 23° C. and 0% relative humidity. This permeability is reduced from the unfilled polymer by 4.8 times. Results are also shown in Table 5 below.

TABLE 5
Formulations at higher solid content - no concentration step

| | Solid | | | | |
|---|---|---|---|---|---|
| | Content | Thickness | Barrier Properties | | |
| Formulation | % | microns | OTR | Permeability | X Reduction |
| 38764-13-3 | 30 | 2.4 | 38.7 | 0.48 | 4.8 |
| (Example 31) | | | | | |

There is thus provided an aqueous barrier coating composition in the form of an aqueous dispersion comprising: (a) water; (b) a polyester matrix polymer; (c) a platy or hyperplaty kaolin functional additive having an average shape factor of at least about 40:1, the composition optionally including a dispersant and thickener and being further characterized in that: (i) the composition has a solids content of from more than 20 weight percent, up to 70 percent by weight; (ii) the composition has a weight ratio of polyester matrix polymer:kaolin filler of from 4:1 to 0.75:1; and (iii) a film formed from the composition exhibits at least 5-fold reduction in oxygen permeability as compared with a like film formed of said polyester matrix polymer. In particular embodiments, the aqueous compositions may have a solids content of at least 25 percent by weight; a solids content of at least 30 percent by weight; a solids content of at least 35 percent by weight; a solids content of at least 40 percent by weight or a solids content of at least 45 percent by weight.

The weight ratio of polyester matrix polymer:kaolin additive is generally from 3:1 to 1:1; typically filler is from 2.5:1 to 1.5:1. The kaolin filler oftentimes has an average shape factor of at least 50:1; at least 60:1; at least 70:1; at least about 80:1; at least about 90:1; or at least about 100:1; generally the platy to hyperplaty kaolin filler has an average shape factor of from 40:1 to 150:1. The kaolin filler has a mean particle size (d₅₀) ranging from about 0.1 μm to about 2 μm, preferably ranging from about 0.25 μm to about 1.5 μm.

Advantageously, the aqueous coating composition is concentrated by evaporating off a portion of water in order to increase the total solids content by at least 20 percent; by at least 50 percent; or by at least 100 or 150 percent and further comprises a dispersant.

In another aspect of the invention, there is provided a method of making a barrier coating composition comprising the steps of: (a) providing a first aqueous dispersion containing a polyester matrix resin; (b) providing a second aqueous dispersion containing a kaolin filler having an average shape factor of at least about 40:1; (c) admixing the first dispersion and the second dispersion; and (d) concentrating the admixed first and second dispersions by evaporating water therefrom such that solids content of the admixed dispersion is increased by at least 20 percent. Preferably, the method further comprises the step of pretreating the kaolin with acid prior to mixing the dispersions. The acid may be chosen from acetic acid, citric acid or glycine or a combination thereof.

In another aspect of the invention, there is provided a polyester barrier film derived from an aqueous coating composition comprising (a) water; (b) a polyester matrix polymer; (c) a kaolin filler having an average shape factor of at least about 40:1, the composition optionally including a dispersant and a thickener and being further characterized in that: (i) the composition has a solids content of from 25 to 70 percent by weight; and (ii) the composition has a weight ratio of polyester matrix polymer:kaolin filler of from 4:1 to 0.75:1, wherein the film exhibits at least 5-fold reduction in oxygen permeability as compared with a like film formed of said polyester matrix polymer. The film typically exhibits at least 10-fold reduction in oxygen permeability as compared with a like film formed of said polyester matrix polymer, preferably exhibits at least 15-fold reduction in oxygen permeability as compared with a like film formed of said polyester matrix polymer and generally exhibits from 5-fold to 30-fold reduction in permeability as compared with a like film formed of said polyester matrix polymer.

The film usually has a platy or hyperplaty clay content of from 20 weight percent to 60 weight percent, such as from 25 weight percent to 40 weight percent, as well as a thickness of at least 1 micron. A thickness of at least 5 microns is suitable in many applications; while thicknesses of from 1 micron to 20 microns are generally readily achieved.

While the invention has been described in connection with numerous embodiments, modifications of those embodiments within the spirit and scope of the present invention will be readily apparent to those of skill in the art. The invention is defined in the appended claims.

1. An aqueous barrier coating composition in the form of an aqueous dispersion comprising:
(a) water;
(b) a polyester matrix polymer;
(c) a kaolin filler having an average shape factor of at least about 40:1, the composition optionally including a dispersant and thickener and being further characterized in that:
(i) the composition has a solids content of from more than 20 weight percent, up to 70 percent by weight;
(ii) the composition has a weight ratio of polyester matrix polymer:kaolin filler of from 4:1 to 0.75:1; and
(iii) a film formed from the composition exhibits at least 5-fold reduction in oxygen permeability as compared with a like film formed of said polyester matrix polymer.

2. The aqueous barrier coating composition according to claim 1, having a solids content of at least 25 percent by weight.

3. The aqueous barrier coating composition according to claim 1, having a solids content of at least 30 percent by weight.

4. The aqueous barrier coating composition according to claim 1, having a solids content of at least 35 percent by weight.

5. The aqueous barrier coating composition according to claim 1, having a solids content of at least 40 percent by weight.

5A. (canceled)

6. The aqueous barrier coating composition according to claim 1, wherein the weight ratio of polyester matrix polymer:kaolin filler is from 3:1 to 1:1.

7-14. (canceled)

15. The aqueous barrier coating composition according to claim 1, wherein the kaolin filler has a mean particle size (d₅₀) ranging from about 0.1 □m to about 2 □m.

16. (canceled)

17. The aqueous barrier coating composition according to claim 1, wherein the composition is concentrated by evaporating off a portion of water in order to increase the total solids content by at least 20 percent.

18. The aqueous barrier coating composition according to claim 1, wherein the composition is concentrated by evaporating off a portion of water in order to increase the total solids content by at least 50 percent.

19. The aqueous barrier coating composition according to claim 1, wherein the composition is concentrated by evaporating off a portion of water in order to increase the total solids content by at least 100 percent.

20. The aqueous barrier coating composition according to claim 1, wherein the composition is concentrated by evaporating off a portion of water in order to increase the total solids content by at least 150 percent.

21. The aqueous barrier coating composition according to claim 1, wherein the composition is concentrated by evaporating off a portion of water in order to increase the total solids content by at least 20 percent and up to 150 percent.

22. A method of making a barrier coating composition comprising the steps of:
(a) providing a first aqueous dispersion containing a polyester matrix resin;
(b) providing a second aqueous dispersion containing a kaolin filler having an average shape factor of at least about 40:1;
(c) admixing the first dispersion and the second dispersion; and
(d) concentrating the admixed first and second dispersions by evaporating water therefrom such that solids content of the admixed dispersion is increased by at least 20 percent.

23. The method according to claim 19, further comprising the step of pretreating the kaolin with acid prior to mixing the dispersions.

24. The method according to claim 22, wherein said acid is chosen from acetic acid, citric acid or glycine or a combination thereof.

25. (canceled)

26. The method according to claim 22, wherein the step of concentrating the admixed dispersion is effective to increase the solids content of the admixture by at least 100%.

27. The method according to claim 22, wherein the step of concentrating the admixed dispersion is effective to increase the solids content of the admixture by up to 150%.

28. A polyester barrier film derived from an aqueous coating composition comprising (a) water; (b) a polyester matrix polymer; (c) a kaolin filler having an average shape factor of at least about 40:1, the composition optionally including a dispersant and a thickener and being further characterized in that: (i) the composition has a solids content of from 25 to 70 percent by weight; and (ii) the composition has a weight ratio of polyester matrix polymer:kaolin filler of from 4:1 to 0.75:1, wherein the film exhibits at least 5-fold reduction in oxygen permeability as compared with a like film formed of said polyester matrix polymer.

29. The barrier film according to claim 28, wherein the film exhibits at least 10-fold reduction in oxygen permeability as compared with a like film formed of said polyester matrix polymer.

30-37. (canceled)

38. The aqueous barrier coating composition according to claim 1, having a solids content of at least 45 percent by weight.
